(19) United States
(12) Patent Application Publication
(10) Pub. No.: US 2013/0264017 A1
(43) Pub. Date: Oct. 10, 2013

(54) MODULAR WINDOW FOR AN AIRCRAFT INCLUDING AN SPD LENS AND AN OPAQUE SHADE

(71) Applicant: MSA AIRCRAFT PRODUCTS LTD., San Antonio, TX (US)

(72) Inventors: Nicholas C. Mohat, San Antonio, TX (US); Michael Spraggins, San Antonio, TX (US)

(21) Appl. No.: 13/848,806

(22) Filed: Mar. 22, 2013

Related U.S. Application Data
(63) Continuation of application No. 13/361,939, filed on Jan. 30, 2012.
Application No. 13/361,939 is a continuation of application No. 12/420,151, filed on Apr. 8, 2009, now abandoned.
(60) Provisional application No. 61/131,311, filed on Jun. 6, 2008.

(51) Int. Cl. B64C 1/14

(52) U.S. Cl. CPC B64C 1/1484
USPC 160/90

(57) ABSTRACT

A modular window for use in a vehicle, such as an airborne vehicle, is provided. The modular window includes a suspended particle device (“SPD”) film, the SPD film making up one of the lenses of the modular The window typically includes an opaque shade movable between an opened and closed position, in spaced apart relation to the reveal mounted SPD lens. The opaque shade can move between an open and closed position with the opaque shade. In an open position, the light passing through the modular window unit is controlled by controlling the opacity of the SPD lens. When the opaque shade is in a closed position, the opaque shade substantially prevents any light from passing through the modular window unit regardless of the opacity of the SPD lens.

This application is a continuation of prior U.S. application Ser. No. 13/361,939, filed Jan. 30, 2012, which claimed priority from U.S. application Ser. No. 12/420,151, filed Apr. 8, 2009, which claimed priority from U.S. Provisional Application Ser. No. 61/131,311, filed Jun. 6, 2008.

### FIELD OF THE INVENTION

Modular windows, including modular windows for aircraft.

### BACKGROUND OF THE INVENTION

Modular windows are used in aircraft to provide natural lighting to the interior thereof. Incorporated herein by reference is U.S. Pat. No. 4,679,610 (Spraggins 1986). The function of window shades is to control the amount of light entering the interior of the aircraft. Typical prior art modular aircraft windows include clear, transparent Lexan® plastic outer lens, a frame, a shade assembly including a shade moveable between and opened and closed position, the shade being substantially opaque. A reveal, clear inner lens and an inboard overlay panel may also be incorporated in typical prior art modular aircraft windows.

As used herein, the terms “SPD film” or “light valve film” mean at least one film or sheet comprising a suspension of particles used or intended for use by itself or as part of a light valve. The light valve film or SPD film comprises either (a) a suspension of particles dispersed throughout a continuous liquid phase enclosed within one or more rigid or flexible solid films or sheets, or (b) a discontinuous phase of a liquid comprising dispersed particles, the discontinuous phase being dispersed throughout a continuous phase of a rigid or flexible solid film or sheet. The light valve film or SPD film may also comprise one or more other layers such as, without limitation, a film coating or non-opaque sheet, or combination thereof, which may provide the light valve film or SPD film with (1) scratch resistance (2) protection from ultraviolet radiation (3) reflection of infrared energy, and/or (4) electrical conductivity for transmitting an applied electric or magnetic field to the activatable material.

U.S. Pat. No. 5,409,734 exemplifies a type of light valve film that is formed by phase separation from a homogeneous solution. Light valve films made by cross-linking emulsions are also known.

One SPD film suitable for use disclosed herein is manufactured by Research Frontiers, Woodbury, N.Y.; and available from Inspect Tech, Ft. Lauderdale, Fla.

### SUMMARY OF THE INVENTION

The device is a modular window for use in a vehicle, such as an airborne vehicle, is provided. The modular window includes a suspended particle device (“SPD”) film, the SPD film making up one of the lenses of the modular window. The window typically includes an opaque shade movable between an open and closed position, in spaced apart relation to the reveal mounted SPD lens. The opaque shade can move between an open and closed position with the opaque shade. In an opened position, the light passing through the modular window unit is controlled by controlling the opacity of the SPD lens. When the opaque shade is in a closed position, the opaque shade substantially prevents any light from passing through the modular window unit regardless of the opacity of the SPD lens.

The device disclosed includes a modular window with an SPD lens, the window having a separate opaque shade that can be moved between an opened and closed position, the use of a reveal typically to hold and position the SPD lens, and an optional inner lens creating a modular assembly for installation to an aircraft interior to control the amount of light coming into the aircraft.

A modular window for a vehicle, the modular window comprising a shade panel, a shade assembly having an opaque shade member and a lower shade rail, an electric motor, a reveal having an outer perimeter walls defining an outer lens opening, an SPD outer lens dimensioned for engagement with the opening of the reveal; and a drive assembly for engaging the motor and the shade assembly for moving the shade member between an open and closed position.

A method is disclosed for using a concave, modular window unit having an electric motor driven opaque shade and an SPD lens, the shade and lens in spaced, overlapping relation, means, known in the art, for selectively controlling the opacity of the SPD lens, means, known in the art, for controlling the electric motor, the method comprising the steps of: installing the modular window between the aircraft interior and exterior, with the opaque shade typically closer to the aircraft interior; selecting an opacity level for the SPD lens; and selecting a position between or including an open and closed position for the opaque shade.

### BRIEF DESCRIPTION OF THE DRAWINGS

FIG. 1 is an exploded perspective view as viewed from the front of Applicants' novel combination SPD lens with an opaque shade assembly.

FIG. 1A is a cross-sectional view of a monocoque embodiment of Applicants' novel aircraft window showing its unitary modular structure as well as the manner in which the shade is substantially sealed from the environment.

FIG. 2 is a perspective view of Applicants' novel window installed in an aircraft interior as installed in an aircraft interior, as viewed from the interior.

FIG. 3 is an exploded perspective view of Applicants' modular aircraft window as viewed from the rear.

FIG. 3A is a partial cross-sectional view of the reveal illustrating a lip for mounting an SPD lens thereto.

FIGS. 3B and 3C are respective and side elevational views of the reveal for use with Applicants' outer lens.

FIG. 4 is an exploded perspective view of components of Applicants' novel SPD lens.

FIG. 5 is a perspective view, partially cut away, of an alternate preferred embodiment of a form of Applicants' invention.

### DETAILED DESCRIPTION OF THE PREFERRED EMBODIMENTS

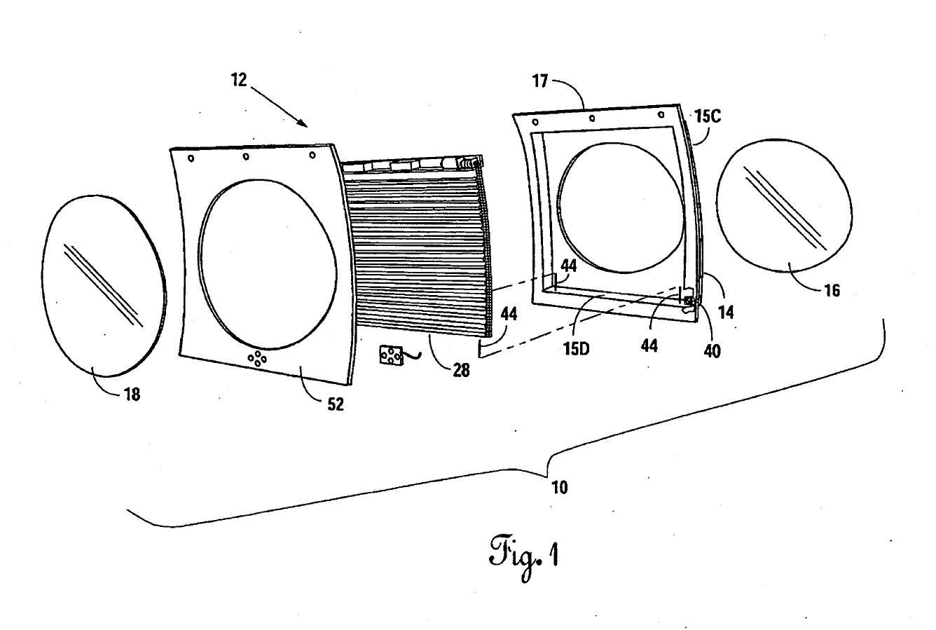

FIGS. 1, 2, 3, 3A-3C illustrate an embodiment of an SPD lens used with modular window assembly 10, hereinafter novel window. Applicants' novel window is seen to be, in a preferred embodiment, of modular construction. Modular means a single unitary structure that needs only to be attached to an aircraft interior, to provide for the control of light entering the interior from the aircraft exterior. With installation, one need only “plug in” (if electronic) components as set forth herein. It may include a shade assembly 12 for joining to reveal 14 on the outboard side thereof. An SPD outer lens 16 is configured, typically oval and curved, to join an outer lip 57 of the reveal 14. An inner lens 18 may also be provided, non-opaque plastic, such as Lexan or an SPD lens.

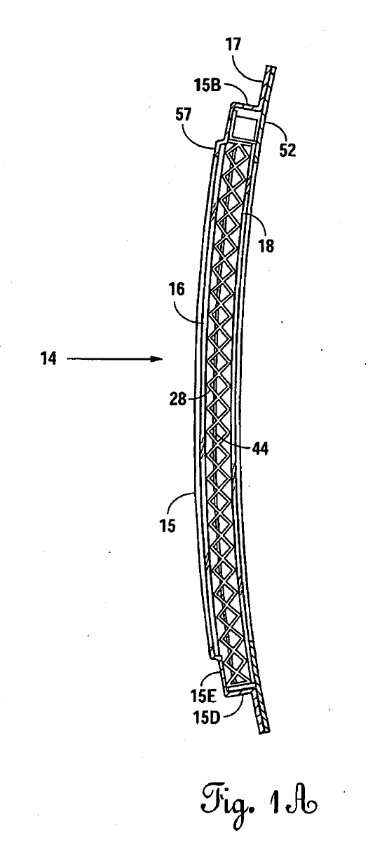

The outer lens 16, typically including Suspended Particle Device (SPD) or member will respond to the application of an electric potential (provided, for example, from an aircraft electrical system), by selectively changing its opacity in known ways, for example, responsive to a control module 56. The SPD outer lens is electrically actuated and controllable to control the amount of light coming therethrough, responsive to an electric signal traveling through an SPD lens switch 24 (see FIG. 2).

Shade assembly 12 typically includes a lower shade rail 34 and an opaque shade 28, which may be the hexagonal shade Duette® material disclosed in the '610 patent attached hereto and incorporated herein by reference or any other material or structure, for example, a “Roman Shade.” Moreover, shade assembly 12 typically engages an electric motor 30 and drive assembly 32 for moving the shade between an opened and closed position (closed position illustrated in FIG. 1). Electric motor drives for shade and shade assembly are known in the art. FIG. 2 illustrates a shade switch 22 capable of initiating movement of shade 28 between an opened and closed position.

Applicants' novel use of a combination of an opaque shade 28, typically in a shade assembly 12, and an SPD outer lens 16, typically mounted in a reveal 14, provides the cabin occupant the option of substantially complete opacity provided by the maximum light blockage accomplished by lowering the opaque shade (see FIG. 1).

Typically, an SPD lens alone, such as SPD outer lens 16, will, even in the maximum opaque position, not provide substantially complete light blockage, especially in bright sunlight. Thus, the user of Applicants' device may selectively raise or lower the opaque shade 28 of shade assembly 12 to accomplish complete opacity (for the part of the outer lens covered by the shade) and thus achieve control of the light received in the interior of the cabin from the outer lens.

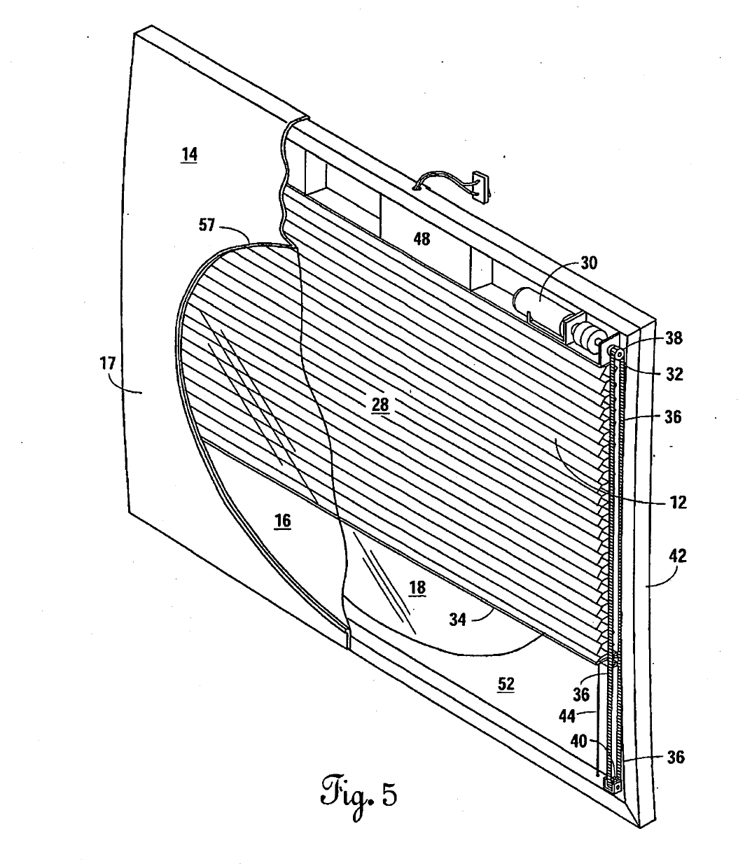

Shade assembly 12 may include a shade member 28 with a lower edge attached to a shade rail 34, and an upper edge attached to an upper shade rail 46. The upper shade rail may be engaged with or support a drive assembly 32 engaging an electric motor 30, the drive assembly driving a drive belt 36 (such as a toothed belt) through a drive sprocket 38. A driven sprocket 40 is provided and the lower shade rail, being attached to the drive belt, will move up and down as the motor energizes the drive sprocket and moves the belt up and down in ways known in the art. A driven sprocket 40 is mounted either to the reveal, as in the frameless, monocoque embodiment illustrated in FIGS. 1-3C or in the frame 42 as illustrated in FIG. 5.

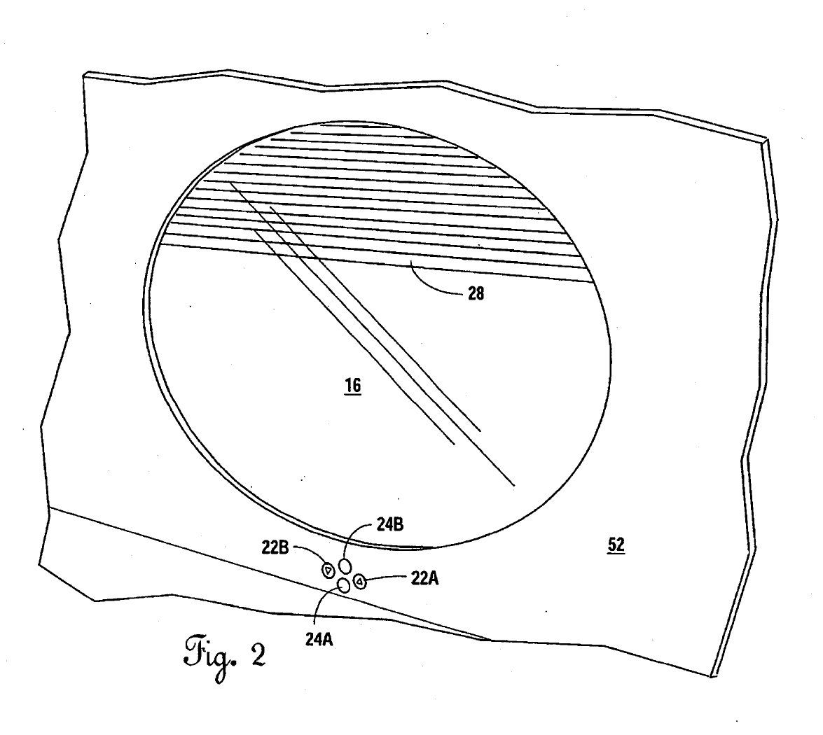

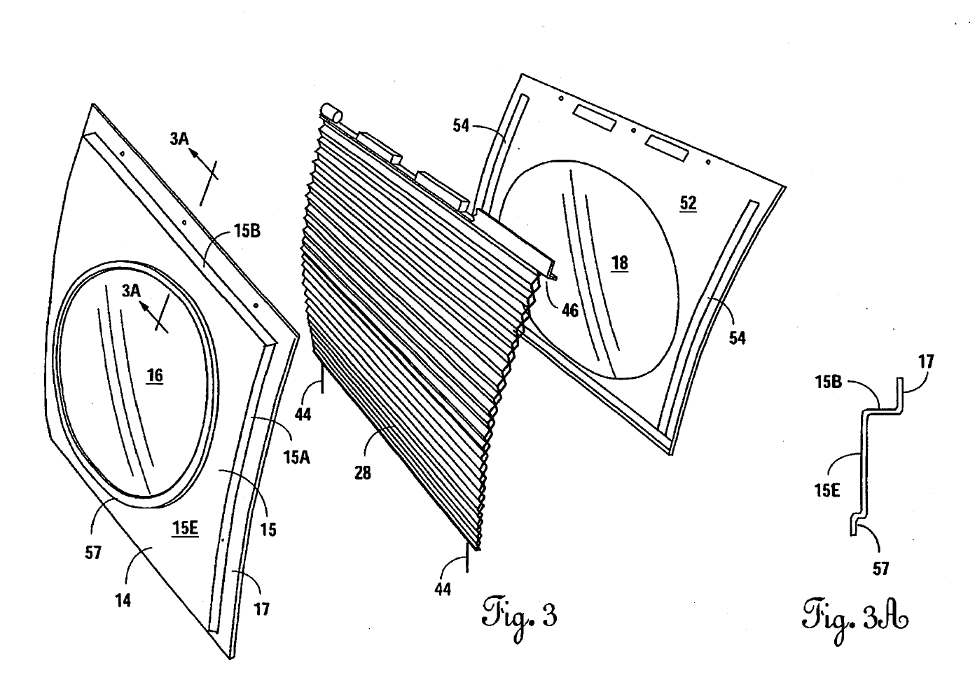

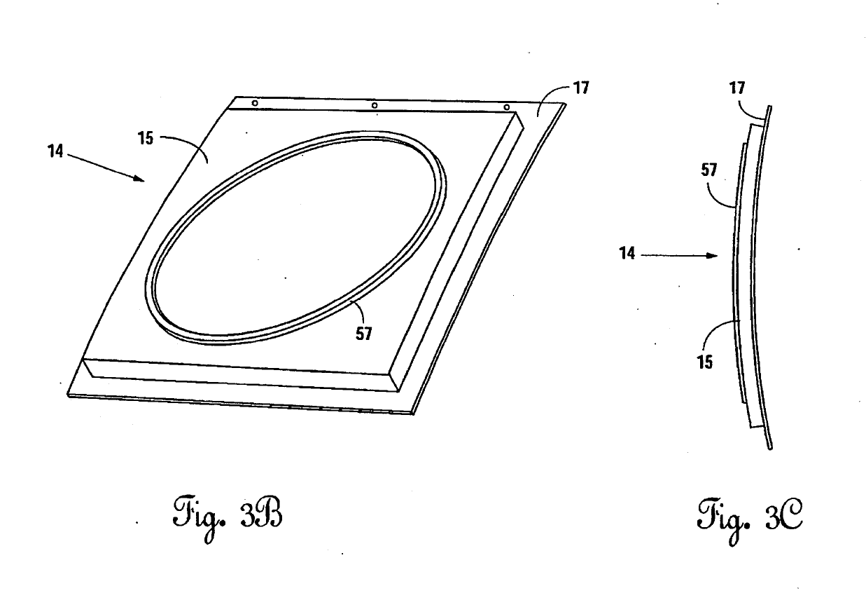

As seen in FIGS. 1, 3, and 3A-3C, it may be seen that reveal 14 may include a box-like enclosure or walled opening 15, which may be generally rectangular comprising walls 15a, 15b, 15c, and 15d, which walls join an outer flange 17. The box-like enclosure 15 with a curved wall 15e having an inner rim or lip 57 defining an outer lens opening and acting as a mounting surface for lens 16 is dimensioned to substantially receive upper shade rail 46 with the components mounted thereto. Upper shade rail 46 may be attached by fasteners or other means known in the art to a surface of reveal 14, for example, an inner surface of wall 15e. Moreover, it is seen that driven sprocket 40 and strings comprising level mechanism 44 may engage walls of the reveal, for example, driven sprocket is seen to engage wall 15d of the reveal in FIG. 1 as are strings comprising leveling mechanism 44. When shade panel 52, typically stiff or rigid, is secured to reveal/shade sub-assembly, box or walled structure 15 encloses the shade assembly and substantially seals the shade in a six walled enclosure defined by rigid shade panel 52 (with or without inner lens 18) and reveal 14. That is to say, this embodiment of Applicants' device is “frameless” or monocoque, wherein the functionality of the frame is incorporated into a reveal 14 and in a preferred embodiment to the combination reveal/shade panel assembly, which defines a box-like enclosure or structure for at least partially enclosing the shade and for rigidly locating or otherwise engaging a shade rail or other mounting means for an electric motor and additional components of the shade mechanism thereto. This enclosure “sandwiches” and substantially seals the shade assembly, drive assembly, motor, etc. between the shade panel and outer reveal. When the shade panel 52 includes an inner lens, air cannot readily circulate around the opaque shade, which will remain relatively dust-free.

Typical of the prior art provide a frame, seen in FIG. 5, which frame includes frame members to mount the motor and other components thereto, and which frame was adapted to receive a reveal thereupon. There is a monocoque embodiment illustrated herein (FIGS. 1-3C), having a shade included in a shade assembly as well as a means to engage an upper shade rail, motor, drive sprocket, and optionally additional components, provided for direct engagement to the box or box shaped insert 15 dimensioned and adapted to receive these components.

In a preferred embodiment, the upper shade rail 46 is provided for mounting the drive and control components thereto, which upper shade rail also engages the upper edge of shade 28. In this embodiment, the shade rail serves the mounting and locating function for the shade itself and it in turn is engaged to or with the reveal, typically a box insert 15.

A frame 42 typically rectangular may be provided, typically made up of four members, such as the upper member, lower member, and two side members illustrated in FIG. 5. A leveling mechanism 44 may be provided engaging the frame and the lower shade rail to maintain the lower shade rail in level position as it moves between the opened and closed positions. Further details of the leveling mechanism of the frame and the like may be found in the '610 patent, incorporated herein by reference. FIG. 5 illustrates the use of outer lens 16 engaged with a reveal, which in turn will be engaged to the frame 42 and thus provide a modular window for engagement to an aircraft interior.

FIG. 3 illustrates the use of an SPD outer lens 16 in combination with a reveal 14 wherein shade assembly 12 has upper shade rail 46, which also may support the electric drive motor 30, motor control module 48, and an SPD control module 50. The upper frame rail 46 may then be engaged either with rigid shade panel 52 (not shown), which may include an inner lens 18 or inserted within the box 15 of the reveal 14 (as illustrated in FIGS. 1-3C). Reveal 14 may engage the upper shade rail 46 by threaded fasteners or the like. Shade panel 52 or reveal 14 may be a stiff material, such as ⅛ inch thick Divinycell® or a multiply fiberglass skin on each side or other suitable material. Moreover, on an outer surface along either of the side edges of shade panel 52 may be mounted abrasion strips 54, typically made from Teflon® tape, on which the shade material of shade 28 and/or the lower shade rail 34 and/or the drive belt 36 may ride as the lower shade rail and shade moves along a curved path between an opened and a closed position.

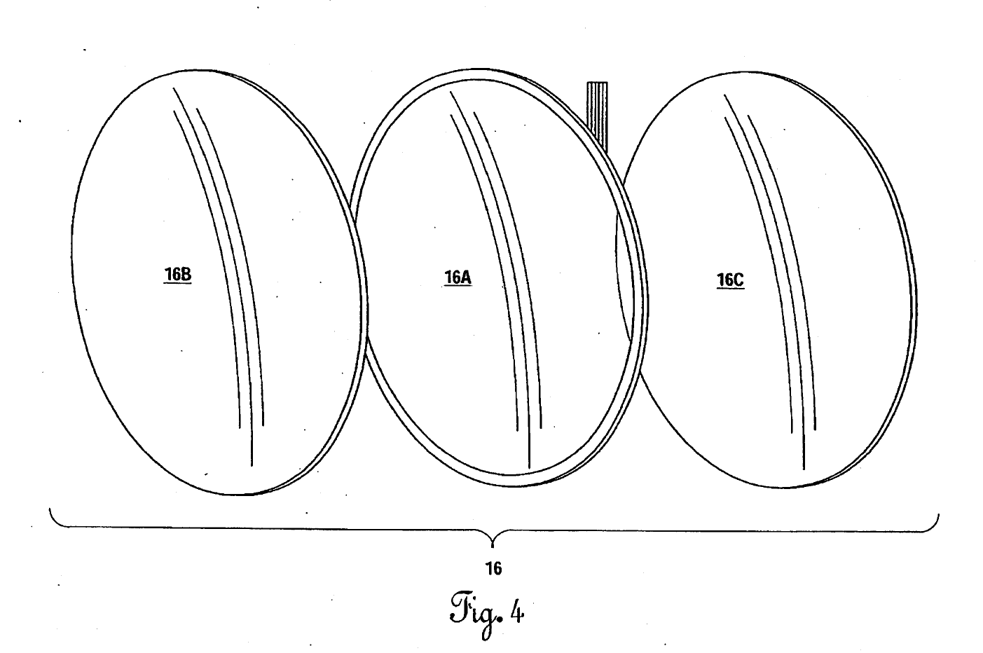

FIG. 4 illustrates a manner in which outer lens may contain SPD film, which may be sandwiched between an inner member 16B and an outer member 16C. That is to say, SPD lens 16 may be comprised of SPD film member 16A that is sandwiched between clear members for protection and for ease of engagement to the reveal, for example, 60/1000 inch Lexan® members. FIG. 3 illustrates the manner in which the SPD lens 16 engages a lip on reveal 14.

In an alternate preferred embodiment, inner lens 18 may be comprised of an SPD film member and would, in a preferred embodiment, be “sandwiched” as is the outer film member 16A. In yet another embodiment, both the inner and outer lens may include SPD film. In yet another embodiment, the opaque shade and related structure is omitted and the inner and/or outer lens includes SPD film.

In practice, a modular unit 10 is installed in an aircraft interior in ways known in the trade, typically adjacent the passenger compartment or seat, with shade panel 52 on the inside, and with reveal 14 at, near or adjacent an outer window of the aircraft fuselage (not shown). Opaque shade 28 is on the interior side and is typically rectangular and large enough to overlap the SPD lens 16 (when the opaque shade is lowered or closed), which is typically on the outside of the unit and may be round, oval or rectangular. The inner lens may be the same shape as the outer lens or different and may be larger. The opaque shade is typically larger than the longest dimension of the largest of the two lenses (when the shade is in the closed position). Furthermore, the modular window is installed and used by the passenger or flight attendant by operating the switches and selectively determining an opacity for the SPD lens, utilizing one switch 24A for obtaining a darker (greater opacity) lens or a second switch 24A for obtaining a lighter (less opacity) outer lens. The passenger or flight attendant may also selectively control an opacity level for the entire modular unit by raising and lowering the opaque shade using switches 22A and 22B to raise and l9ower the opaque shade.

In all of the embodiments set forth herein and as seen in FIG. 1A, it is seen that the unit is modular and that an opaque shade member is sandwiched between an inner panel and an outer panel, such as a reveal, and further that at least one of the two panels contains an SPD lens. Furthermore, an embodiment shows that both an inner lens and an outer lens, the inner panel and the outer panel defining the unit, substantially seal the opaque shade member, such that no dust or the like can affect the shade, and also providing some insulation from the temperature differences across the unit and to sound moving through the unit. That is to say, the unit is both modular and, in a preferred embodiment, having both an inner and outer lens, is substantially sealed at a perimeter thereof with the inner panel outer perimeter joining the reveal outer perimeter with or without the use of a frame.

The use of the novel SPD lens with this electronic control mechanism may be used in the embodiment illustrated herein; that is, one having an electric drive. However, an embodiment of the shade enclosed herein may be used with a window that has an electric drive moving the shade between an opened and closed position as well as manual override to move the shade when the electricity is down. Electronically driven aircraft window shades with manual override are known in the art. See, for example, U.S. Pat. No. 6,230,784, entitled “Electrically Operated Aircraft Window With Sliding Takeup Spool,” filed Sep. 24, 1998, and incorporated herein by reference.

Further, a manual version (no electric drive) of the window shade operating mechanism may also be used with the SPD lens as set forth herein. Manually operated window shade mechanisms are known in the art. See, for example, U.S. Pat. Nos. 4,679,610; 5,082,053; 4,998,576; 5,662,152; and 6,481,486, all of the foregoing being incorporated herein by reference. A drive assembly may be either engaged with an electric motor (as illustrated herein) or a means for manual movement, such as a handle found in the foregoing patents.

The reveal and/or the shade panel may be made from multiply prepreg fiberglass skin with 3 to 4 layers of 181 fiberglass (approx. 3/32 inch thick) molded as necessary.

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A modular window for a vehicle, the modular window comprising:
a shade panel;
a shade assembly having an opaque shade member and a lower shade rail;
an electric motor;
a reveal, the reveal having a flange and also walls defining an outer lens opening;
a suspended particle device (SPD) outer lens dimensioned for engagement with the outer lens opening of the reveal; and
a drive assembly for engaging the motor and the shade assembly for moving the shade member between an open and closed position.

2. The modular window for a vehicle of claim 1, wherein the shade assembly, electric motor, and drive assembly engage the reveal and the reveal engages the shade panel, comprising a modular assembly.

3. (canceled)

4. The modular window for a vehicle of claim 1, wherein the reveal is a box shaped enclosure having walls that are generally rectangular and dimensioned to receive the shade assembly.

5. The modular window for a vehicle of claim 1, further comprising an electric motor controller and switch, for moving the shade between an open and a closed position; and
an SPD lens control module and switch for controlling the amount of light passing through the SPD lens.

6. The modular window for a vehicle of claim 3, further comprising an electric motor controller and switch, for moving the shade between an open and a closed position; and
an SPD lens control module and switch for controlling the amount of light passing through the SPD lens.

7. The modular window for a vehicle of claim 3, wherein the box shaped enclosure is generally rectangular and is dimensioned to receive the shade assembly; and
further comprising an electric motor controller and switch, for moving the shade between an open and a closed position.

8. The modular window for a vehicle of claim 3, wherein the shade assembly is substantially between the reveal and the shade panel, and wherein the shade member of the shade assembly is capable of completely covering the outer lens when the shade member is in a closed position.

9. The modular window for a vehicle of claim 8, wherein the shade panel includes walls defining an opening for an inner lens and an inner lens.

10. The modular window for a vehicle of claim 9, wherein the inner lens is larger than the outer lens, and wherein the shade member is large enough so that it completely covers the inner lens opening of the shade panel when the shade member is in a closed position.

11. The modular window for a vehicle of claim 9, wherein the inner and outer lens are both oval.

12. The modular window for a vehicle of claim 11, wherein the SPD lens includes at least one transparent protective member.

13. The modular window for a vehicle of claim 1, wherein the shade panel includes walls defining an opening for an inner lens and further comprising an inner lens.

14. The modular window for a vehicle of claim 13, wherein the inner lens is larger than the outer lens, and wherein the shade member of the shade assembly is large enough so that it completely covers the inner lens when the shade member is in a closed position.

15. The modular window for a vehicle of claim 1, further comprising a frame;
wherein the electric motor shade assembly and a shade panel and drive assembly engage the frame; and
wherein the frame engages the reveal such that the shade member is between the reveal and the shade panel.

16. The modular window for a vehicle of claim 1, wherein the box shaped enclosure is generally rectangular and is dimensioned to receive the shade assembly.

17. A window for a vehicle, the window comprising:
a modular unit, including a shade panel, the shade panel having walls defining an inner lens opening;
a shade assembly having an opaque shade member in the lower shade rail, means for moving the shade assembly between an open and closed position;
a shade panel having walls defining an inner lens opening;
a reveal, the reveal having walls defining an outer lens opening;
a pair of lenses, at least one of the pair being an SPD lens, one of the lenses adapted to engage the shade panel and the other of the lenses adapted to engage the reveal;
a drive assembly for engaging the shade assembly for moving the shade member between the open and closed position;
wherein the shade panel engages the outer reveal so as to substantially seal the shade assembly therebetween to substantially limit the ability of dust and the like to accumulate on the shade member of the shade assembly, and wherein the shade of the shade assembly covers at least the inner lens when in a closed position.

18. A window for a vehicle of claim 17, wherein the means for moving the shade assembly between an open and closed position include an electric motor.

19. A window for a vehicle of claim 18, wherein the SPD lens of the pair is adapted to engage the outer lens opening of the reveal.

20. A window for a vehicle of claim 19, wherein the SPD lens includes a pair of clear protective plastic lenses engaged thereto.

21. A window for a vehicle of claim 17, wherein the modular unit is curved in cross-section.
